(19) United States
(12) Patent Application Publication
(10) Pub. No.: US 2026/0352341 A1
(43) Pub. Date: Nov. 5, 2026

(54) OPTICAL TRANSMITTER

(71) Applicant: 1FINITY Inc., Kawasaki-shi (JP)

(72) Inventors: Yohei SOBU, Kawasaki (JP); Toshihiko MORI, Isehara (JP); Hanwei CHEN, Kawasaki (JP); Shinsuke TANAKA, Hiratsuka (JP)

(73) Assignee: 1FINITY Inc., Kawasaki-shi (JP)

(21) Appl. No.: 19/554,207

(22) Filed: Mar. 2, 2026

(30) Foreign Application Priority Data
Mar. 6, 2025 (JP) 2025-035703

(51) Int. Cl. H04B 10/556; H04B 10/516

(52) U.S. Cl. CPC H04B 10/5561; H04B 10/5167

(57) ABSTRACT

An optical transmitter includes an optical DAC that drives each of a plurality of modulation units using a binary driver and outputs an optical signal. The optical DAC is configured to generate a pair of data signals with different temporal timings for each gradation, output the pair of data signals of each gradation to a pair of modulation units of the plurality of pairs of modulation units provided for each of the plurality of modulation units, perform optical modulation on the pair of data signals of each gradation, and output the optical signal.

### CROSS REFERENCE TO RELATED APPLICATIONS

This application is based upon and claims the benefit of priority of the prior Japanese Patent Application No. 2025-035703, filed on Mar. 6, 2025, the entire contents of which are incorporated herein by reference.

### FIELD

The embodiments discussed herein relate to an optical transmitter.

### BACKGROUND

An optical transmitter in a large-capacity optical transmission system such as a digital coherent transmission system or an intensity modulation-direct (IM-DD) system converts a digital signal output from a digital signal processor (DSP) into an electric analog signal by an electric digital analog converter (DAC), amplifies the electric analog signal by an analog driver to generate a drive signal having an amplitude of several volts, and drives a traveling-wave-type optical modulator to generate a multilevel optical modulation signal.

On the other hand, in order to reduce power consumption of an optical transmitter, an optical DAC technology has been studied as an architecture for generating a multilevel optical modulation signal by directly inputting a digital signal to a segmented optical modulator (an optical modulator having multiple phase shifters connected in multiple stages on an optical waveguide). An optical transmitter using an optical DAC optically converts a digital signal into an analog signal by amplifying a drive signal generated from a digital signal for each bit corresponding to a symbol by a binary driver and inputting the drive signal as it is to a segmented lumped parameter optical modulator. That is, the bit combining function of the conventional electric DAC is transferred to the optical domain. Since the electric DAC and the linear driver may be removed from the conventional architecture and a CMOS inverter driver may be used as a binary driver array, it is expected to reduce power consumption and reduce the size and increase the density of an electric IC by making the electric IC into one chip using a CMOS.

The optical DAC transmitter addresses increasing speed. As described in A. H. Talkhooncheh, et al., J. of Solid-state circuits, vol.58, No.1, pp.30-43, (2023) and Y. Sobu, et al., in Proc.OFC2024, Th2A.11, (2024), the symbol rate of an optical DAC in which a CMOS inverter driver and a segment optical modulator are integrated is limited to a vicinity of 50 Gbaud. One reason is that it is necessary to form a CMOS inverter driver in multiple stages in the current amplification for driving the load of the segment optical modulator, and an erroneous determination occurs without exceeding a threshold value at the time of switching a value from 0 to 1 or from 1 to 0 due to insufficient band of a transistor in that region, and a signal partially disappears.

On the other hand, as a conventional technique related to increasing the speed of an optical transmitter, for example, there is an optical transmission device to which time interleaving is applied in which signals applied to two optical modulators are shifted in a time direction by time interleaving of a precoder to double a baud rate. There is also an optical modulator module that achieves high-speed modulation by sequentially delay-driving MZ optical modulators connected in series. In addition, there is a method of increasing the channel capacity for transmitting a composite multi-level signal by shifting each channel with respect to an adjacent channel by combining time division multiplexing and multi-level multiplexing of signals. In addition, there is an optical transmission system that performs multi-stage modulation on an MZ optical modulator by sequentially activating multi-stage ADCs to increase data rate. In addition, there is an FDM multiplexing optical communication system that performs sequential transmission every 4 bytes using an MZ optical modulator. For example, refer to Japanese Laid-Open Patent Publication No. 2008-219760, International Publication No. WO 2013/018263, Published Japanese-Translation of PCT Application, Publication No. 2010-528549, U.S. Patent Application Publication No. 2007/0222654, and U.S. Patent Application Publication No. 2002/0039211.

### SUMMARY

According to an aspect of an embodiment, an optical transmitter includes an optical DAC that drives each of a plurality of modulation units using a binary driver and outputs an optical signal. The optical DAC is configured to generate a pair of data signals with different temporal timings for each gradation, output the pair of data signals of each gradation to a pair of modulation units of the plurality of pairs of modulation units provided for each of the plurality of modulation units, perform optical modulation on the pair of data signals of each gradation, and output the optical signal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram depicting an example of an optical transmitter using an optical DAC according to an embodiment.

FIGS. 2A and 2B is an explanatory diagram of a background art of an optical DAC transmitter.

FIG. 3 is an explanatory diagram of a problem of a CMOS inverter driver accompanying increased speed of an optical DAC.

FIG. 4 is an explanatory diagram of a problem when a concept of a prior art document is applied to an optical DAC.

FIG. 5A is a diagram depicting a configuration example of an optical transmitter according to an embodiment.

FIG. 5B is a diagram depicting a configuration example of an optical transmitter according to an embodiment.

FIG. 6 is a timing chart using three-phase clocks in three interleaves of an RZ signal, which is a premise of the embodiment.

FIG. 7A is an explanatory diagram of data generation according to the embodiment.

FIG. 7B depicts a truth table.

FIG. 8A is a timing chart depicting an example of data generation timing in a case of three interleaves.

FIG. 8B is a timing chart depicting an example of data generation timing in a case of three interleaves.

FIG. 8C is a timing chart depicting an example of data generation timing in a case of three interleaves.

FIG. 9 is a flowchart depicting a flow of a data transmission process of the optical transmitter according to the embodiment.

FIG. 10 is an explanatory diagram of a relationship between the number of interleaves that may be realized in the embodiment, number of necessary segments, and operation rate of a CMOS inverter driver.

FIG. 11A is an explanatory diagram of restrictions on the number of interleaves.

FIG. 11B is an explanatory diagram of restrictions on the number of interleaves.

FIG. 12A is a timing chart depicting an example of data generation timing in a case of 4-interleaving.

FIG. 12B is a timing chart depicting an example of data generation timing in a case of 4-interleaving.

FIG. 12C depicts a truth table.

FIG. 12D is a timing chart depicting an example of data generation timing in a case of 4-interleaving.

FIG. 13A is a timing chart depicting an example of signal generation on a positive-side when differential driving of a Mach-Zehnder optical modulator is assumed.

FIG. 13B depicts a truth table.

FIG. 13C is a timing chart depicting a signal generation example on a negative-side in a case where differential driving of the Mach-Zehnder optical modulator is assumed.

FIG. 13D depicts a truth table.

FIG. 14 is a block diagram depicting an example of an overall configuration of an optical transmitter.

### DESCRIPTION OF EMBODIMENTS

First, problems associated with the conventional techniques are discussed. As described above, a problem of the optical DAC is a high baud rate. In order to solve this problem, a high-speed optical signal may be generated by parallelizing low-speed electrical signals in multiple lanes and performing time synthesis (time interleaving) in an optical domain. For example, when the time interleaving technique described in Japanese Laid-Open Patent Publication No. 2008-219760 is applied to an optical DAC, phase modulation of π is required in each modulator divided for interleaving, and multiple bits cannot be combined, so the operable range is limited to only one bit (details of the problem will be described later).

Embodiments of the disclosed optical transmitter will be described in detail with reference to the drawings. The optical transmitter according to the embodiment is applied to, for example, an optical transceiver including a modularized optical transmitter and optical receiver or a single optical transmitter.

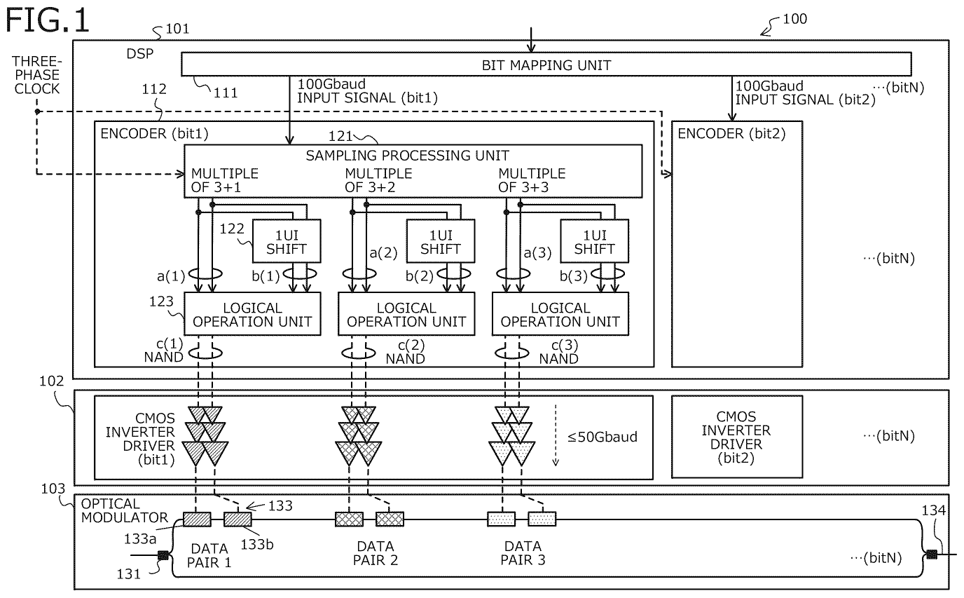

FIG. 1 is a diagram depicting an example of an optical transmitter using an optical DAC according to an embodiment. The optical transmitter 100 depicted in FIG. 1 includes a DSP 101, a CMOS inverter driver 102, and an optical modulator 103. FIG. 1 depicts a portion corresponding to an optical DAC that directly drives the optical modulator 103 with a digital signal output from the DSP 101. In FIG. 1, it is assumed that the number of bits of the optical DAC is N and the number of interleaves is 3, which is the minimum value at which the effect of the present disclosure appears.

The optical transmitter (optical DAC) according to the embodiment may operate by a configuration example in which a MZ optical modulator as the optical modulator 103 is driven in a single layer. The optical modulator 103 includes a demultiplexer 131 and phase shifters (segments) 133 on two arms (upper and lower arms are referred to as a positive-side and a negative-side, respectively) after demultiplexing. The phase shifter (segment) 133 provided on the two arms has an electrode of a predetermined length along the length direction of the optical waveguide. The phase shifter 133 modulates an optical signal on the optical waveguide based on data input to the electrode. The optical signals of the two arms are generated by the multiplexer 134.

As depicted in FIG. 1, the optical transmitter 100 according to the embodiment may be implemented by using only one arm on the positive-side of the optical modulator 103 (single-layer driving). The present disclosure may also be implemented in a configuration (differential drive) using a pair of arms on the positive-side and the negative-side of the optical modulator 103.

The DSP 101 outputs data obtained by performing transmission processing on an input signal to the CMOS inverter driver 102. In the DSP 101 of FIG. 1, only components of the optical DAC are depicted, and an input processing unit of an input signal is provided at a pre-stage (not depicted) of the DSP 101.

In the DSP 101 of FIG. 1, a bit mapping unit 111 used as a function of an optical DAC among functions of the DSP and an encoder 112 for each of multiple N bits (bit1, bit2, . . . , and bitN) are described. The CMOS inverter driver 102 and the optical modulator 103 have the same configuration for each bit, and only the internal configuration of bit1 is depicted in FIG. 1.

The bit mapping unit 111 divides the input signal into multiple N bits (bit1, bit2, . . . , and bitN), and outputs the bits to the encoders 112 that correspond to bit1, bit2, bit . . . , and bitN, respectively. For example, the baud rate of the input signal of each bit is 100 Gbaud. The encoder 112 of each bit (bit1, bit2, . . . , and bitN), the CMOS inverter driver 102, and the optical modulator 103, which are units subsequent to the bit mapping unit 111, simultaneously perform the following processes. Although only the process of bit1 will be described below, bit2 to bitN perform the same process as bit1.

The encoder 112 samples the input signal, divides the input signal into three timings (three interleaves), and outputs the divided three pieces of data to the CMOS inverter driver 102. The encoder 112 includes a sampling processing unit 121, a 1UI shift 122, and a logical operation unit 123.

In the embodiment, the optical DAC is operated with the number of interleaves of three or more based on the concept of the return to zero (RZ) system. In a case of the three-interleave operation, the sampling processing unit 121 performs sampling using a clock signal (three-phase clock) having a rate of ⅓ of the input signal, and divides the input signal into three timings. For example, the sampling processing unit 121 generates a data signal a(i) (i is the number of interleaves and is 1 to 3) obtained by performing a process of transitioning when the input signal (bit1) is Hi and maintaining when the input signal (bit1) is Lo at a timing of a multiple of 3+1.

The encoder 112 (sampling processing unit 121) performs division and arithmetic processing on the input signal to divide the input signal into data of a multiple of 3, whereby the symbol rate of data propagating through the CMOS inverter driver 102 may be suppressed to less than 100 Gbaud, which is the symbol rate of the actual input signal. In the example depicted in FIG. 1, the symbol rate of data propagating through the CMOS inverter driver 102 corresponds to ≤50 Gbaud, which is half the rate of the input signal (100 Gbaud).

The 1UI shift 122 branches the output data of the sampling processing unit 121, performs a time shift of 1 unit interval (UI) on the branched data, and generates a data signal b(i).

The logical operation unit 123 is a logic circuit that performs a logical operation. In the configuration example in which the optical modulator 103 is driven in a single layer (posi) in FIG. 1, the logical operation unit 123 performs a NAND operation with respect to the data signal a(i) output by the sampling processing unit 121 and the data signal b(i) output by the 1UI shift 122, and generates a data signal c(i) corresponding to ≤50 Gbaud that actually propagates through the CMOS inverter driver.

Since a(i) and b(i) are differential signals, two types of signals are generated as the data signal c(i). The two types of signals of the data signal c(i) are amplified by the CMOS inverter driver and respectively drive two phase shifters that handle multiples of 3+1 . A set of data input to the two segments is referred to as a data pair 1, and that which handles a multiple of 3+2 and a multiple of 3+3 are referred to as a data pair 2 and a data pair 3, respectively. The signal waveform of the data signal c(i) in the middle of the optical modulator for each i=1 to 3 corresponds to an RZ pulse (details will be described later with reference to the drawings).

The encoder 112 described above generates a waveform satisfying the following by a logical operation.
A signal waveform in the middle of the optical modulator generated by each data pair becomes a waveform corresponding to an RZ pulse.
The rising edge and the falling edge of the RZ pulse are detected by a pair of different phase shifters 133a and 133b.

The CMOS inverter driver 102 amplifies the output of the encoder 112 and outputs the amplified output to the optical modulator 103. The CMOS inverter driver 102 has a multi-stage configuration for current amplification.

The CMOS inverter driver 102 inputs the data signal c(i) to the positive-side of the optical modulator. The optical modulator 103 includes multiple modulation units (phase shifters, segments) in which electrodes having a predetermined length are arranged along the length direction of the optical waveguide (arm). Each modulation unit (phase shifter) of the optical modulator 103 optically modulates (phase modulates) the optical signal based on the electrical signal output by the CMOS inverter driver 102. For example, the optical modulator 103 changes the refractive index of the optical waveguide by injecting a charge (current) into the phase shifter 133, thereby converting and outputting data of the optical signal corresponding to the input electrical signal.

In the embodiment, the optical modulator 103 is a segment type optical modulator in which two (a pair of) phase shifters 133a and 133b are arranged corresponding to c(i) of data pair 1 input per bit (bit1).

For the data of bit1, the data signal c(1) to the data signal c(3) divided into three by the encoder 112 are input to the phase shifters 133 of the optical modulators 103 of the different data pair 1 to data pair 3, respectively. The phase shifter 133 arranged along the optical waveguide on the positive-side generates optical signals corresponding to the data signals of the data pair 1 to the data pair 3 (electrical-to-optical conversion). As a result, among the input signals input to the optical DAC (optical transmitter 100), the data of bit1 is converted into an optical signal by the optical modulator 103 and output. The data of bit2 is also output to the encoder 112, the CMOS inverter driver 102, and the optical modulator 103 in the same manner as bit1.

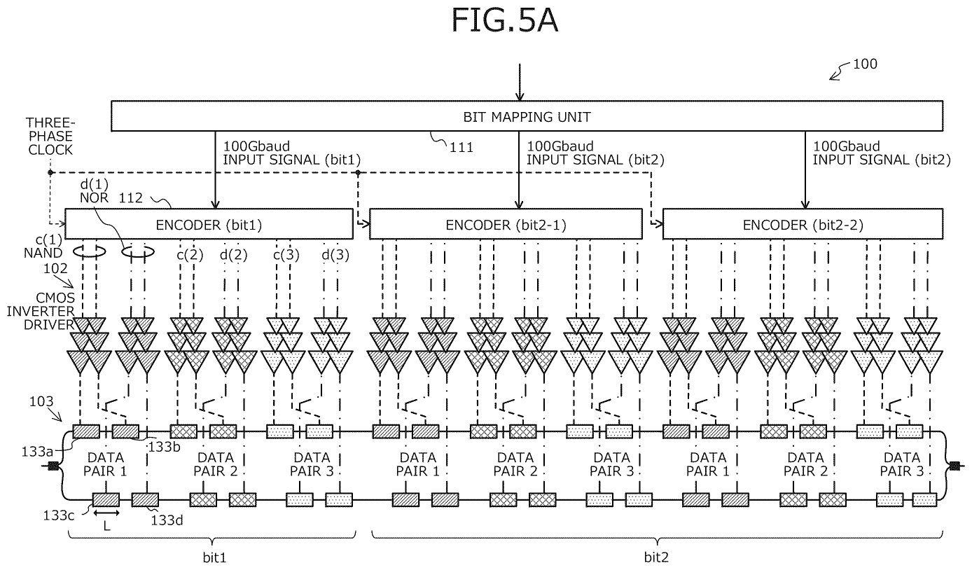

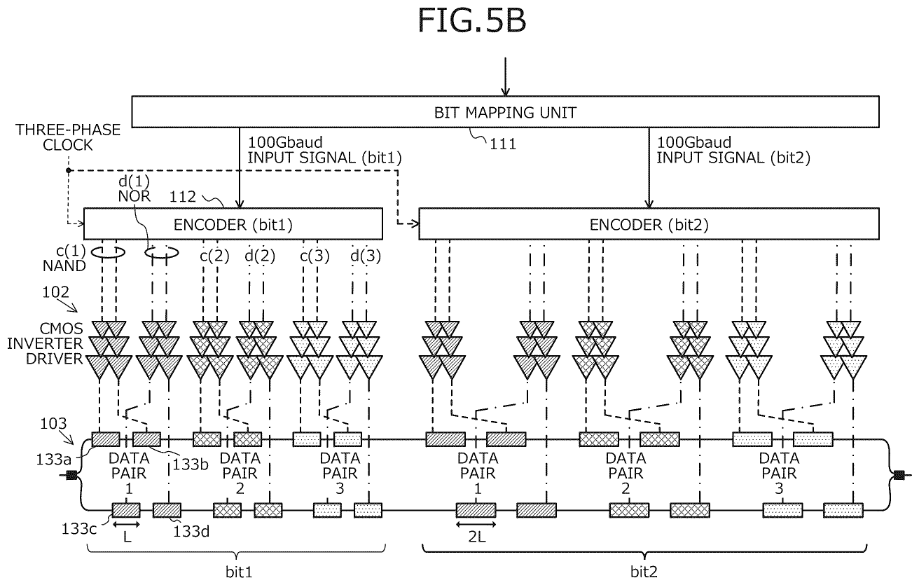

Here, a configuration example in which the optical modulator 103 is differentially driven (posi/nega) will be described (refer to FIGS. 5A and 5B). In the differential driving, the logical operation unit 123 performs a NAND operation with respect to the data signal a(i) output by the sampling processing unit 121 and the data signal b(i) output by the 1UI shift 122. As a result of the NAND operation, a low-speed data signal c(i) is output to the phase shifter 133 on the positive-side of the optical modulator 103. The NOR operation is performed on the data signal a(i) and the data signal b(i) output from the 1UI shift 122, and the low-speed data signal c(i) may be output to the phase shifter 133 on the negative-side of the optical modulator 103.

As described above, in the embodiment, the number of modulators (phase shifters) is increased, and three or more interleaves are applied. For example, in the configuration example depicted in FIG. 1, the number of phase shifters per bit is the number of interleaves 3×2=6. The encoder 112 according to the embodiment performs an encoding process by the sampling processing unit 121, the logical operation unit 123, etc. while applying time interleaving. As a result, for example, even for an electric input signal of 100 Gbaud class, which is difficult for a multistage CMOS inverter driver to handle, stable operation may be performed without erroneous determination by reducing the operation rate to ½ by 3-stage interleaving. Therefore, optical data transmission may be performed at an operation rate that is at least twice that of the CMOS inverter driver 102.

Here, technical background and problems thereof will be described.

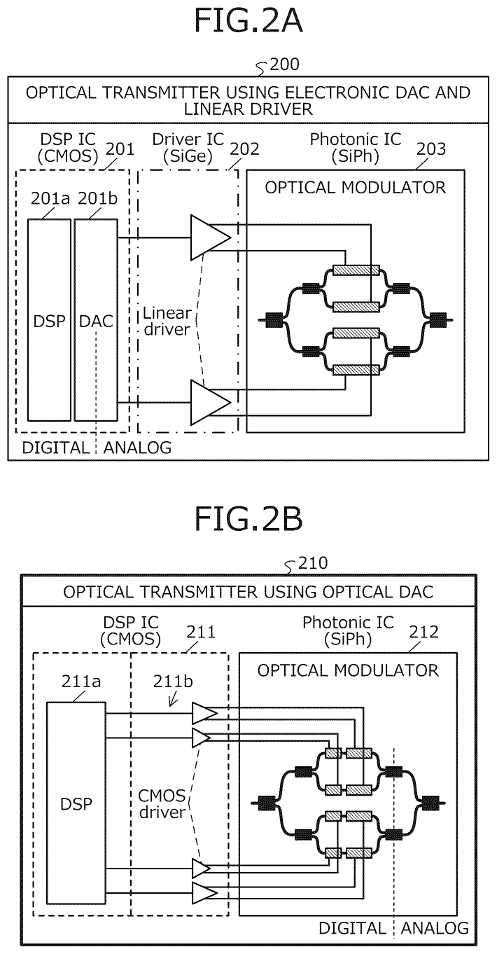

FIGS. 2A and 2B are explanatory diagrams of a background art of an optical DAC transmitter. FIG. 2A is a diagram depicting an architecture of an optical transmitter that uses an electric DAC and a linear driver currently used. FIG. 2B is a diagram depicting an optical transmitter using an optical DAC applied in the embodiment.

The optical transmitter 200 using the electric DAC depicted in FIG. 2A includes a DSP IC 201, a driver IC 202, and an optical modulator 203. The CMOS DSP IC 201 includes a DSP 201a and an electric DAC 201b.

The DSP 201a (input side) is a digital domain, and the electric DAC 201b (output side) to the linear driver IC 202 and the optical modulator 203 are analog domains. The electric DAC 201b drives the optical modulator 203 with the data after DA conversion via the linear driver IC 202, which is formed with SiGe, the optical modulator 203 being formed with SiPh.

In the optical transmitter 210, which uses the optical DAC depicted in FIG. 2B, the bit combining function of the electric DAC 201b is transferred to the optical domain by using the CMOS inverter driver and the segment optical modulator. As a result, both the DSP unit and the driver unit may be configured by CMOS circuits, and when the same technology is used, the electric IC may be formed into a single chip. As a result, the optical transmitter may be reduced in size and increased in density. In this case, the optical transmitter 210 that uses the optical DAC includes a DSP IC 211 and an optical modulator 212.

The CMOS DSP IC 211 includes a DSP 211a and a CMOS inverter driver 211b. The phase shifter input from the DSP IC 211 to the optical modulator 212 are in the digital domain, and the optical output after the output stage (multiplexing unit) of the optical modulator 212 is in the analog domain. In the optical DAC, the CMOS inverter driver array 211b depicted in FIG. 2B is used instead of the electrical DAC and the linear driver IC (SiGe) in FIG. 2A. As a result, the CMOS inverter driver array 211b directly drives the optical modulator 212 in the form of a digital signal, thereby reducing power consumption.

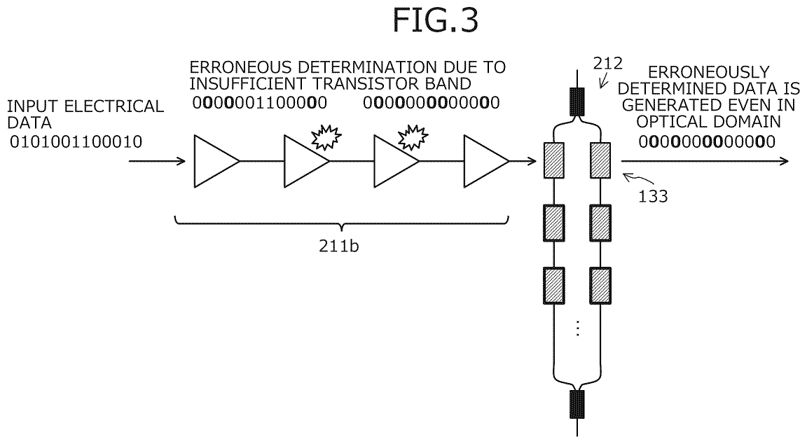

FIG. 3 is an explanatory diagram of a problem of a CMOS inverter driver accompanying increased speed of an optical DAC. FIG. 3 is an enlarged view of the configuration of one bit of the optical DAC (optical transmitter 210) depicted in FIG. 2B. The CMOS inverter drivers 211b are connected in multiple stages in order to drive the optical modulator load and amplify the current.

In FIG. 3, an example is depicted in which the isolated pulse of “010” disappears in the second stage of the CMOS inverter driver 211b with respect to the value “0101001100010” of the input electrical data of the time-series signal sequence and changes to the value “0000001100000”, and then all the data “1” disappears in the third stage and becomes the value “0000000000000”. Since the optical signal is output to the phase shifter 133 of the optical modulator 212 in this state, the phase shifter 133 of the optical modulator 211b outputs the optical signal of the erroneously determined value “0000000000000”, and the value corresponding to the input electrical data cannot be output when the speed of the optical DAC is increased, and erroneously determined data is generated even in the optical domain.

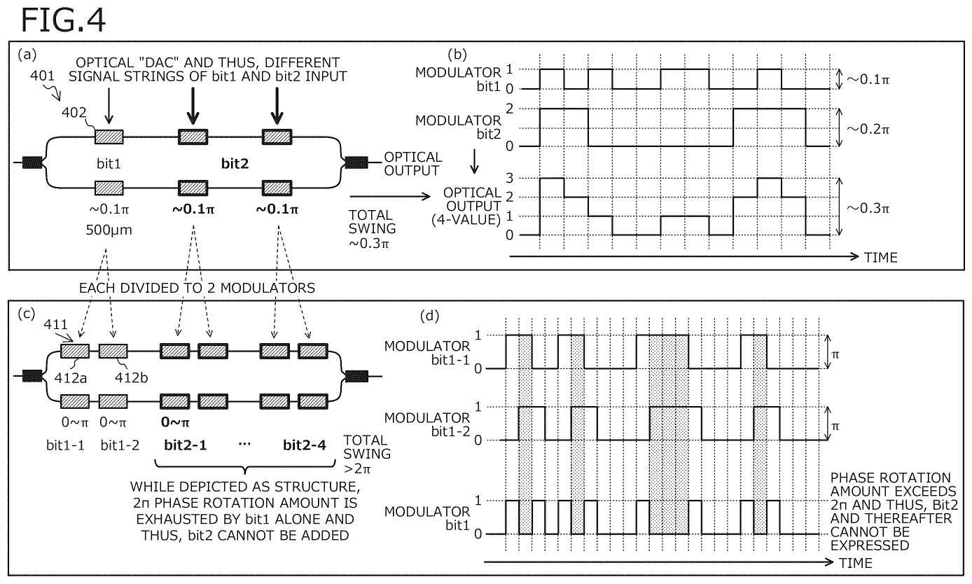

FIG. 4 is an explanatory diagram of a problem when the concept of the prior art document is applied to an optical DAC. In FIG. 4, (a) and (b) depict a configuration of a time-interleaved optical modulator of a 2-bit optical DAC and a concept of a time chart of bit generation. In FIG. (c) and (d) depict a configuration and a time chart of an optical modulator in a case where Japanese Laid-Open Patent Publication No. 2008-219760 is applied to an optical DAC.

In the 2-bit optical DAC, as depicted in (a) of FIG. 4, multiple bit signals are added by the optical modulator 401. In the case of 2 bits, addition is performed so as to obtain a four-value output signal. In (b) of FIG. 4, a horizontal axis represents time, and a vertical axis represents input signals and optical outputs of the phase shifters of bit1 and bit 2, and four-value optical outputs are obtained by generating the input signals of bit1 and bit 2. One phase shifter 402 has a relatively small phase rotation amount of about −0.1π. For example, even in digital coherent optical communication, the total modulation swing (phase rotation amount) is usually about 0.5π or less with consideration of nonlinear influence. In the phase shifter of the optical DAC, the phase rotation amount is adjusted twice for each bit.

On the other hand, in the case of a modulator 411 depicted in (c) of FIG. 4 in which Japanese Laid-Open Patent Publication No. 2008-219760 of the time interleaving is applied to the optical DAC, it is necessary to divide one phase shifter 402 depicted in (a) of FIG. 4 into two (bit1-1, bit1-2) phase shifters 412a and 412b in order to perform the time interleaving. At this time, according to Japanese Laid-Open Patent Publication No. 2008-219760, as depicted in (d) of FIG. 4, phase modulation of 0 to π is necessary in each of the two phase shifters 412a and 412b of the divided bit1-1 and bit1-2, and a phase change amount of 2π of the optical modulator is used in bit1-1 and bit1-2.

The method of Japanese Laid-Open Patent Publication No. 2008-219760 is an interleaving method that takes advantage of the phase rotation of 2π of light so that the output is 0 when the phase change amount of the entire two divided phase shifters is 0, the output is 1 when the phase change amount is π, and the output is 0 when the phase change amount is 2π. In this case, the phase change amount of 2π of light is exhausted by bit1 alone and thus, bit addition (bit1+bit2) of the optical DAC cannot be performed. As described above, when the technique of Japanese Laid-Open Patent Publication No. 2008-219760 is applied to an optical DAC using a CMOS inverter driver, the operable range is only one bit as a structural problem, and multiple bits cannot be realized. Note that Japanese Laid-Open Patent Publication No. 2008-219760 does not assume generation of multiple bits. Further, since the amplitude of the CMOS inverter driver is limited to 0.9 V, it is not easy to generate a phase change amount of 2π. In this case, when phase modulation of 2π is to be obtained in a configuration including a CMOS and SiPh modulator, the modulator length (segment length) becomes very long (about 1 cm), and miniaturization and high density as an optical DAC cannot be achieved.

To cope with these problems, in the optical transmitter (optical DAC) according to the embodiment, as depicted in FIG. 1, the number of phase shifters is increased and three or more interleaves (three data pairs) are applied. According to the embodiment, time interleaving may be applied to an optical DAC. In addition, the operation rate may be increased by a unique encoding process even when the CMOS inverter driver 211b (CMOS DSP IC 211) is used. Further, the 2π phase modulation in (d) of FIG. 4 in which the problem of the background art occurs is not necessary, and it is possible to achieve both the optical DAC that performs the time interleaving and the optical DAC that performs the bit addition.

FIGS. 5A and 5B are diagrams depicting a configuration example of an optical transmitter according to an embodiment. FIGS. 5A and 5B are configuration examples of two bits and three interleaves as in FIG. 1, the same components as those in FIG. 1 are denoted by the same reference numerals and the optical modulator 103 portion for bit2 omitted in FIG. 1 is mainly depicted. Further, in FIG. 1, while the optical modulator 103 is driven in a single layer, in FIGS. 5A and 5B, a configuration example of differential driving is depicted. The internal configuration of the encoder 112 depicted in FIG. 1 is not depicted.

The optical transmitter 100 depicted in FIG. 5A is a configuration example in which the segment lengths L of the phase shifters 133 of the optical modulator 103 for bit1 and bit2 are the same. The encoder 112 outputs a differential signal of positive and negative. The logical operation unit 123 (refer to FIG. 1) in the encoder 112 outputs a data signal c(1), which is a NAND result of the data signal a(1) and the data signal b(1), as an input on the positive-side of the Mach-Zehnder interferometer in the data pair 1 (i=1) of bit1.

A data signal d(1), which is a NOR result of the data signal a(1) and the data signal b(1), is output as an input on the negative-side of the Mach-Zehnder interferometer. The signal on the positive-side is output to the two phase shifters 133a and 133b on the positive-side of the optical modulator 103 for the data pair 1 via the CMOS inverter driver 102. The negative-side signal is output to the two negative-side phase shifters 133c and 133d of the optical modulator for the data pair 1 via the CMOS inverter driver 102.

Also for the data pair 2 (i=2) of bit1, similarly to the case of i=1, the data signal c(2) of the NAND result of the data signal a(2) and the data signal b(2) is output to the two phase shifters 133 on the positive-side of the optical modulator 103 for the data pair 2. Data signal d(2) of the NOR result is output to two phase shifters on the negative-side for data pair 2. Also for i=3 of bit1, similarly to i=1, the data signal c(3) as the NAND result of the data signal a(3) and the data signal b(3) is output to the two phase shifters 133 on the positive-side of the optical modulator 103 for the data pair 3. Further, the NOR result data signal d(3) is output to the two phase shifters 133 on the negative-side for the data pair 2.

When the segment lengths L of the phase shifters 133 of the optical modulator 103 are set to be the same, it is necessary to generate a phase rotation twice as large as that of bit1 for bit2 according to the principle of the optical DAC, so there is a lane (circuit system) for bit2-1 and a lane for bit2-2. The lanes for bit2-1 and bit2-2 have the same circuit and arrangement configuration as bit1.

The optical transmitter 100 depicted in FIG. 5B is a configuration example in which the length of the phase shifter 133 of the lane of bit2 is twice (2L) the length L of the phase shifter 133 of bit1. In this configuration example, the number of pieces of output data of the encoder 112 for bit2 and the number of CMOS inverter drivers 102 and optical modulators 103 may be reduced to half as compared with the configuration example depicted in FIG. 5A. The lane for bit2 (circuit connection arrangement) may be the same as the lane for bit1 except that the length of the phase shifter 133 of the lane for bit2 is twice (2L) the length L of the phase shifter 133 for bit1.

According to the above configuration example, for example, by applying the configuration of FIG. 5B to the configuration example of only the positive-side depicted in FIG. 1, the lane on the bit2 side depicted in FIG. 1 may be made similar to the lane on the bit1 side. In this case, the phase shifter 133 of the optical modulator 103 in the lane on the bit2 side depicted in FIG. 1 may be provided with three data pairs (six in total) having a length twice that of the phase shifter 133 of the bit1.

Here, data generation and operation of the optical transmitter according to the embodiment will be described.

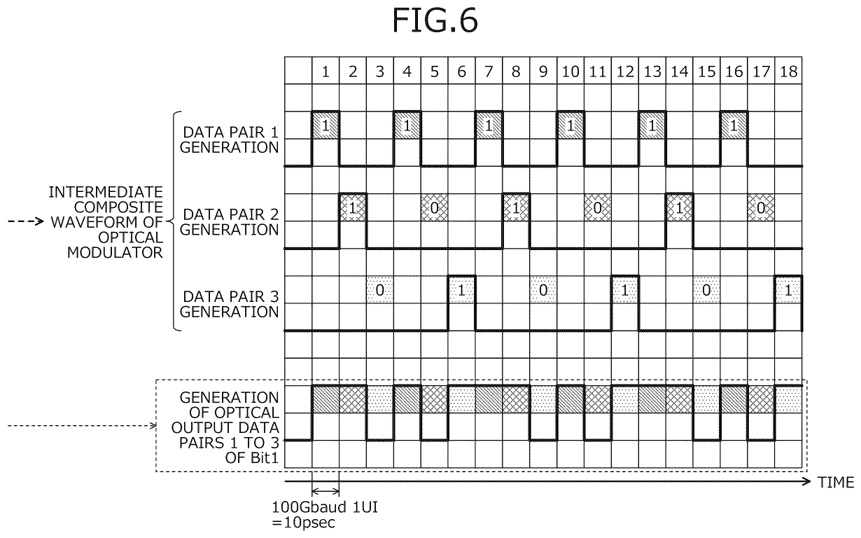

FIG. 6 is a timing chart using three-phase clocks in three interleaves of an RZ signal, which is a premise of the embodiment. Each data pair 1-3 corresponds to an RZ pulse at a rate of ⅓ of the input signal. The data pair 1, the data pair 2, and the data pair 3 are operated to determine only the timing slots of “a multiple of 3+1”, “a multiple of 3+2”, and “a multiple of 3”, respectively. In the example depicted in FIG. 6, the encoder 112 of bit1 generates pulses of three time-timings separately for every three pairs.

For example, on the timing slots, the timing slots (referred to as slots thereof) allocated for the data pair 1 are slot numbers 1, 4, 7, 10, and . . . . The slots for data pair 2 are slot numbers 2, 5, 8, 11, and . . . . The slots for data pair 3 are slot numbers 3, 6, 9, 12, and . . . . Then, the optical modulator 103 generates an optical signal based on the data pairs 1 to 3 to output an optical signal of bit1.

However, in the basic concept of the 3-interleave of the RZ signal depicted in FIG. 6 as it is, for example, when the input signal is 100 Gbaud, the input signal becomes a high-speed short pulse of 1 UI=10 psec, whereby erroneous determination occurs in the CMOS inverter.

Therefore, in the embodiment, the encoder 112 generates input signals to the data pairs 1 to 3 so that the generated waveforms of the data pairs 1 to 3 (two phase shifters) become the waveforms depicted in FIG. 6. However, the encoder 112 does not directly generate the waveform, and an example of a data generation method will be described below.

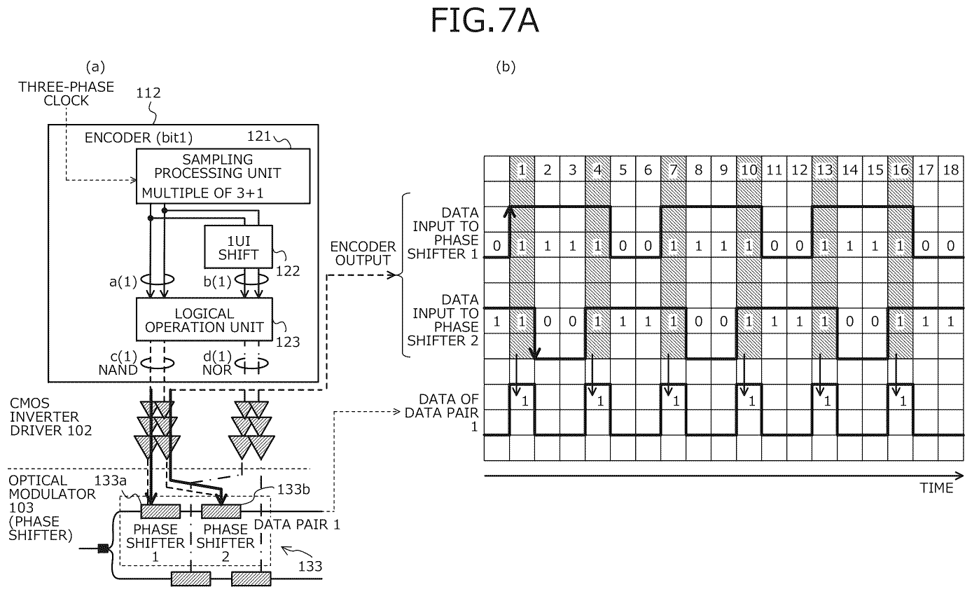

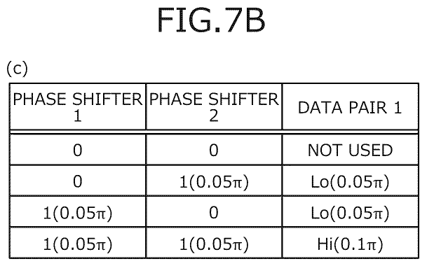

FIG. 7A is an explanatory diagram of data generation according to the embodiment. In FIG. 7A, (a) schematically depicts only lanes of data pair 1 corresponding to “a multiple of 3+1”. In FIG. 7A, (b) depicts a timing chart for generating the data pair 1.

The encoder 112 operates to determine only a multiple of 3+1 timing slots for the data pair 1 as described above. Then, the embodiment has the following characteristics 1., 2. and 3.
1. Two phase shifters 133a and 133b (two pieces of data) are used to generate data of the data pair 1 (a signal corresponding to an RZ pulse of a rate of ⅓ of the actual operation rate). As depicted in (b) of FIG. 7A, different phase shifters are assigned to rise and fall with respect to one pulse of the data pair 1. For example, in a slot number 1 in (b) of FIG. 7, the phase shifter 1 (133a) detects the rising of one pulse, and the phase shifter 2 (133b) detects the falling of one pulse. The short pulse of the data pair 1 is generated by the pair of data. In FIG. 7, (b) depicts an example in which all the values of the data of the data pair 1 are “1”.
2. the Encoder 112 Generates Data Such That One of the Phase Shifter 1 (133a) and the phase shifter 2 (133b) for the data pair 1 is in a state of 1 (phase rotation state) and the other is in a state of 0 (no phase rotation) in slots other than the timing thereof (respective slot thereof, multiple of 3+1).
3. In the next timing slot after the value has changed, the value is not changed (the values of the slot numbers 5 and 6 corresponding to 2 UI in the phase shifter 1 are “0”).

As a result, the data of the data pair 1 may be ensured for 2 UI as the timing slot of the value 0, and even when the rate of the input signal is high, the operation rate of the electric signal input to the CMOS inverter driver 102 becomes half thereof, thereby preventing signal loss in the multistage CMOS inverter driver.

In FIG. 7B, (c) depicts a truth table of the phase shifters 1 and 2 and the data pair. The value in parentheses ( ) in the table is an example of the phase rotation amount. In the embodiment, when the values of the phase shifter 1 (133a) and the phase shifter 2 (133b) are (1,1), the data pair 1 is Hi. When the values of the phase shifter 1 (133a) and the phase shifter 2 (133b) are (0,1) or (1,0), the data pair 1 is Lo. The combination of the values (0,0) of the phase shifters 1 and 2 is not used.

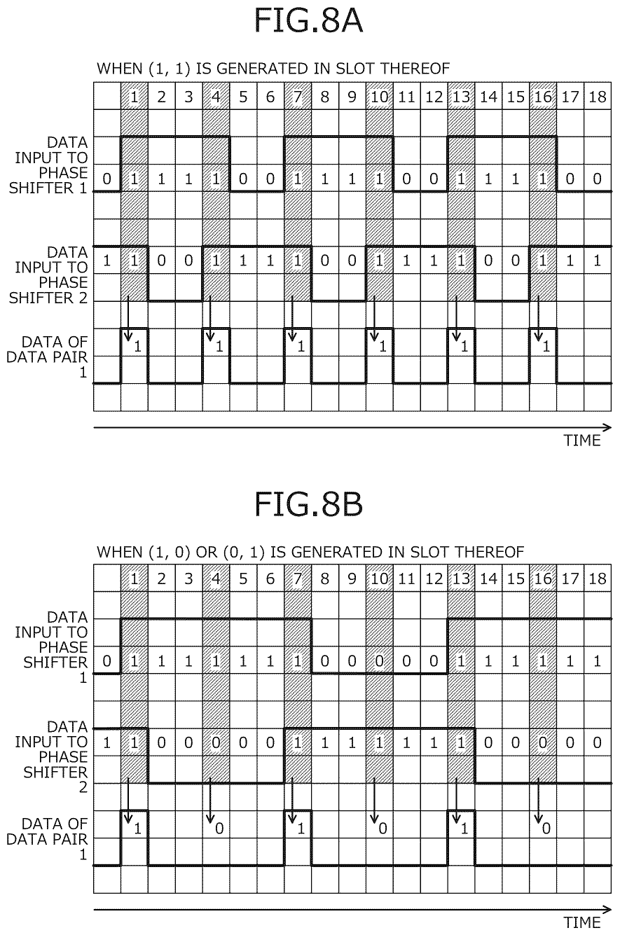

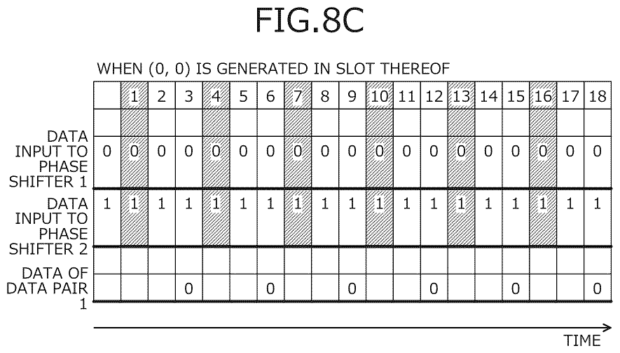

FIGS. 8A, 8B, and 8C are timing charts depicting examples of data generation timing in a case of three interleaves. According to the truth table depicted in FIG. 7B, an example in which each value is generated in the slot thereof will be described.

The requirements of the waveforms of the phase shifters 1 and 2 are as described in the above section 3. In the next timing slot after the value has changed, the value is not changed. Further, based on the truth table of FIG. 7B, any one of (1,1), (1,0), and (0,1) is generated in the slot thereof. Then, except for two time slots other than the slot thereof, one phase shifter satisfies 1 and the other phase shifter satisfies 0 (either (1,0) or (0,1)). The timings of the slot thereof are slot numbers 1, 4, 7, 10, 13, and 16.

According to the above requirements, FIG. 8A depicts a timing chart when the data of the data pair 1 is always 1 at the timing of the slot thereof (1, 1, 1, . . . ). FIG. 8B depicts a timing chart in a case where the data of the data pair 1 alternates between 1 and 0 at the timing of the slot thereof (1, 0, 1, 0, . . . or 0, 1, 0, 1, . . . ).

FIG. 8C depicts a timing chart in which the data of the data pair 1 is always 0 at the timing of the slot thereof.

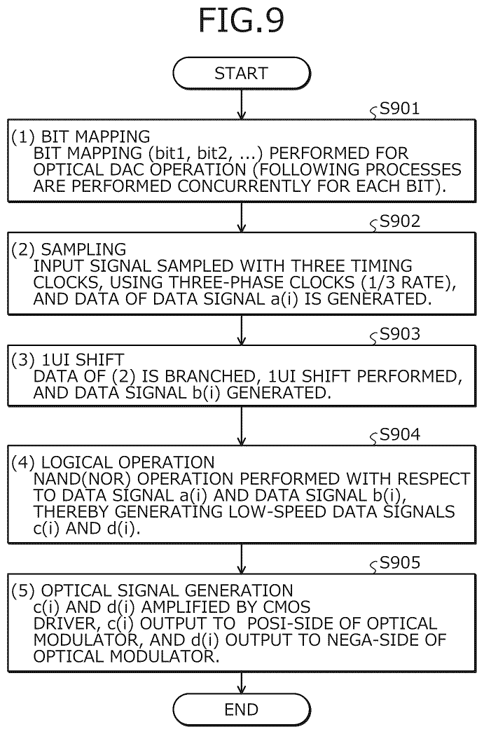

FIG. 9 is a flowchart depicting a flow of a data transmission process of the optical transmitter according to the embodiment. The optical transmitter 100 sequentially performs the following processes.
(1) Bit mapping (step S901) is performed. The bit mapping unit 111 of the DSP 101 of the optical transmitter 100 performs bit mapping (bit1, bit2, . . . ) for the optical DAC operation. The process at step S902 and subsequent steps is simultaneously performed for each bit.
(2) Sampling (step S902) is performed. In the case of three interleaves, the sampling processing unit 121 of the encoder 112 of the DSP 101 samples the input signal with three timing clocks using three-phase clocks (⅓ rate). In the above example, at the timing of the slot thereof of “a multiple of 3+1”, a process of transition is performed when the input signal (bit1) is Hi, or a process of maintaining is performed when the input signal (bit1) is Lo, and data of the data signal a(1) is generated. When a three-phase clock is used, i=1 to 3.

Then, at the timing of the slot thereof of “a multiple of 3+2”, a process of transition when the input signal (bit1) is Hi or a process of maintaining when the input signal (bit1) is Lo is performed to generate data of a data signal a(2). Further, at the timing of the slot thereof of “a multiple of 3+3”, a process of transition when the input signal (bit1) is Hi or a process of maintaining when the input signal (bit1) is Lo is performed to generate data of a data signal a(3). In the three-interleave, since there are three data pairs in total, the data signal a(i) also has three types of i=1 to 3.
(3) 1UI shift (step S903) is performed. The 1UI shift 122 of the encoder 112 of the DSP 101 branches the data of (2) after sampling, performs 1UI shift, and generates a data signal b(i).
(4) A logical operation (step S904) is performed. The logical operation unit 123 of the encoder 112 of the DSP 101 generates a low-speed data signal c(i) by performing a NAND operation with respect to the data signal a(i) and the data signal b(i). In addition, a low-speed data signal d(i) is generated by performing a NOR operation with respect to the data signal a(i) and the data signal b(i).
(5) An optical signal is generated in the optical domain (step S905). The optical transmitter 100 amplifies the data signal c(i) and the data signal d(i) output from the DSP 101 by the CMOS inverter driver 102, outputs the data signal c(i) to the phase shifters 1 and 2 (133a and 133b) on the positive-side of the optical modulator 103, and generates an optical signal (electrical-to-optical conversion). The data signal d(i) is output to the phase shifters 1 and 2 (133c and 133d) on the negative-side of the optical modulator 103 to generate an optical signal.

In the process example depicted FIG. 9, an example in which the optical modulator 103 has positive-side and negative-side has been described. However, as depicted in FIG. 1, a process that uses only the positive-side (there is no output on the negative-side) may be performed.

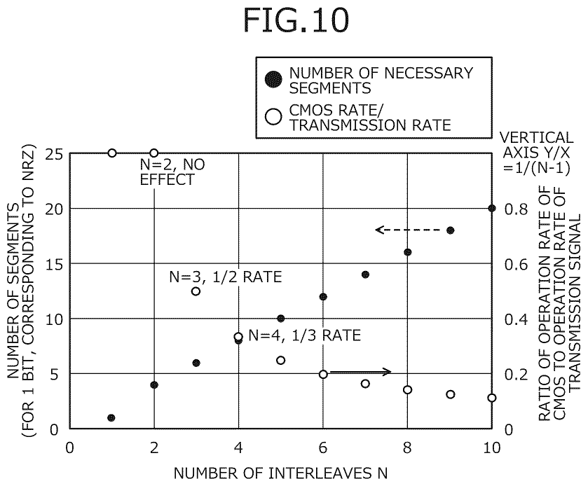

FIG. 10 is an explanatory diagram of a relationship between the number of interleaves that may be realized in the embodiment, the number of necessary segments, and the operation rate of the CMOS inverter driver. The vertical axis (left) indicates the number of segments (1 bit, corresponding to NRZ), the horizontal axis indicates the number of interleaves N, and the vertical axis (right) indicates the ratio of the operation rate of the CMOS inverter driver 102 to the operation rate of the transmission signal.

When the operation rate of the input data signal output from the DSP is X [Gbaud], the operation rate of the data signal passing through the CMOS inverter driver 102 (the rate of the signal input to the optical modulator 103) is Y [Gbaud], and the number of interleaves is N, the number of phase shifters 133 per bit is 2N, and the operation rate Y of the data signal passing through the CMOS inverter driver 102 is (N−1) times X.

As depicted in FIG. 10, the relationship between the number of necessary segments and the number of interleaves (black circles in the figure) is proportional, and the relationship between the number of interleaves N and the number of segments (CMOS rate/transmission rate, white circles in the figure) is inversely proportional. For example, when the operation speed of the CMOS inverter driver 102 is 50 [baud], the feasible symbol rate is (N−1) times. Thus, in the embodiment, “no effect” is obtained when the number of interleaves N=2, and the embodiment is applicable when the number of interleaves N=3 or more.

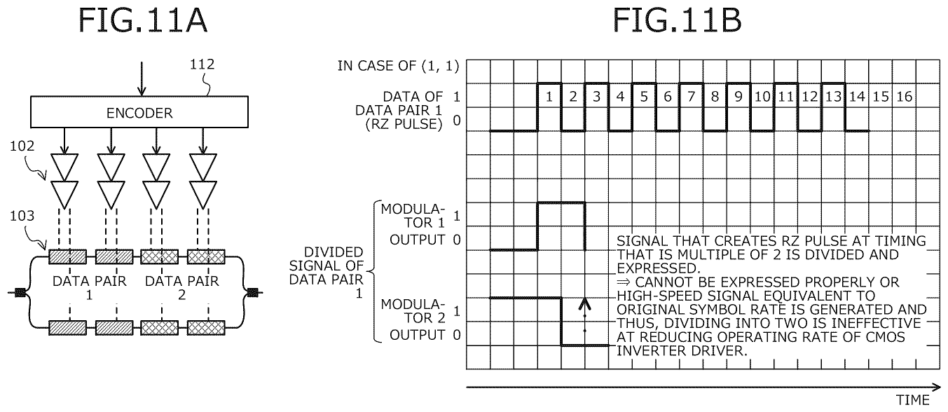

FIGS. 11A and 11B are explanatory diagrams of restrictions on the number of interleaves. FIG. 11A is a configuration diagram of the two-division, and FIG. 11B is a timing chart (only on the positive-side) in the case of the two-division. In the case of two-interleave, two phase shifters corresponding to the data pairs 1 and 2 are necessary, and four phase shifters are components per bit. At this time, while it is necessary to divide and express a signal that generates an RZ pulse at a timing of a multiple of 2 in such a manner that the operation rate may be reduced with respect to the original input signal, this cannot be expressed. When the divided signal of the data pair 1 is forcibly generated, a high-speed signal equivalent to the symbol rate of the original input signal is output. Therefore, in the present disclosure, two interleaves are meaningless, and three or more interleaves are effective.

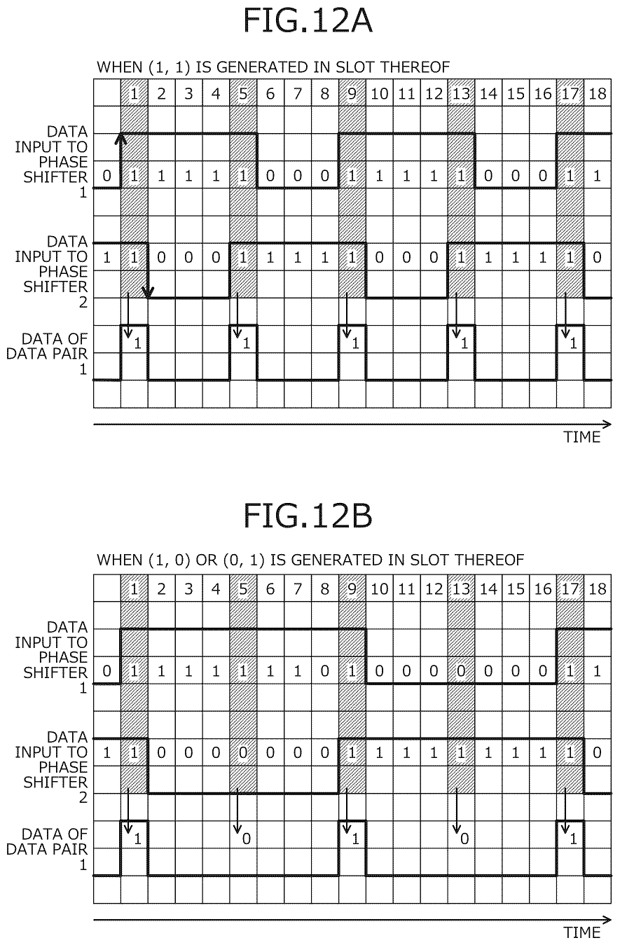

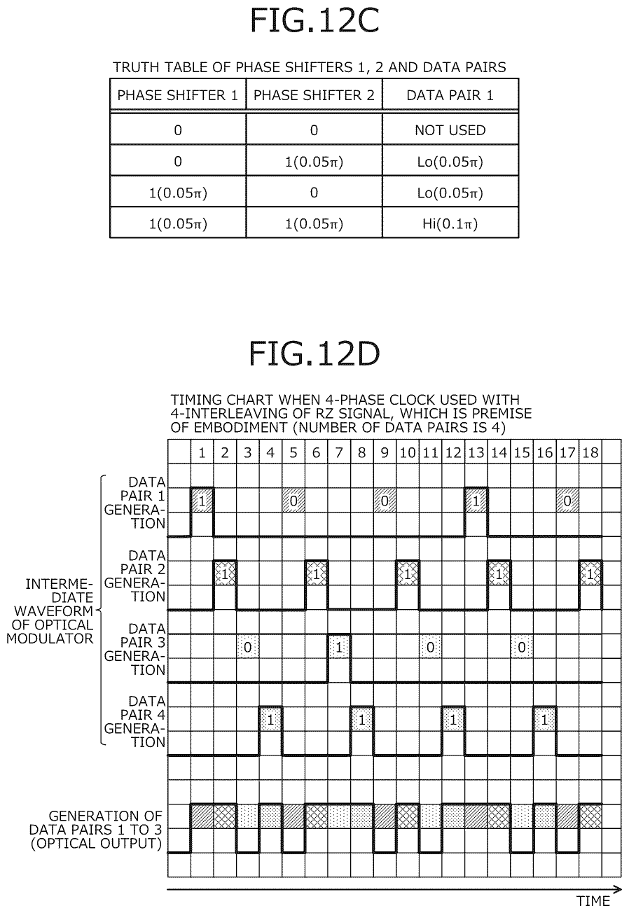

FIGS. 12A, 12B, and 12D are timing charts depicting examples of data generation timing in a case of 4-interleaving. At the time of 4-interleaving, the data pair 1 operates to determine only “a multiple of 4+1” timing slots, the data pair 2 operates to determine only “a multiple of 4+2” timing slots, the data pair 3 operates to determine only “a multiple of 4+3” timing slots, and the data pair 4 operates to determine only “a multiple of 4+4” timing slots. Also, in the case of 4-interleaving, the optical transmitter 100 is assumed to similarly have the configuration characteristics 1., 2. and 3. described above.
1. Two phase shifters 133a and 133b (two pieces of data) are used to generate data of the data pair 1 (a signal corresponding to an RZ pulse at a rate of ¼ of an actual operation rate). Then, for example, in the slot number 1 in FIG. 12A, the phase shifter 1 (133a) detects the rising of one pulse, and the phase shifter 2 (133b) detects the falling of one pulse. The short pulse of the data pair 1 is generated by the pair of data. FIG. 12A depicts an example in which all the values of the data of the data pair 1 are “1”.
2. The encoder 112 generates data such that one of the phase shifter 1 (133a) and the phase shifter 2 (133b) of the data pair 1 is in a state of 1 (phase rotation state) and the other is in a state of 0 (no phase rotation) in slots other than the timing slots thereof (slot thereof, multiple of 4+1 ).
3. In the next timing slot after the value has changed, the value is not changed.

As a result, for the data of the data pair 1, the slot of the value 0 for 3UI may be ensured (the rate of ⅓ of the input signal), and the operation rate of the CMOS inverter driver 102 may be further reduced as compared with the case of 3 interleaving.

FIG. 12A depicts a timing chart when (1,1) is generated at the timing of the slot thereof. FIG. 12B depicts a timing chart when (1,0) or (0,1) is generated at the timing of the slot thereof.

FIG. 12C depicts a truth table of phase shifters 1 and 2 and data pairs in an instance of 4-interleaving. This truth table is the same as the truth table in an instance of three interleaves (FIG. 7B). Also, in the instance of 4-interleaving, when the values of the phase shifter 1 (133a) and the phase shifter 2 (133b) are (1,1), the data pair 1 becomes Hi. When the values of the phase shifter 1 (133a) and the phase shifter 2 (133b) are (0,1) or (1,0), the data pair 1 is Lo. The values (0,0) of the phase shifters 1 and 2 are not used.

FIG. 12D depicts a timing chart of the output data of the data pairs 1 to 4. While the number of data pairs is three in the case of 3-interleaving, the number of data pairs is four in the case of 4-interleaving.

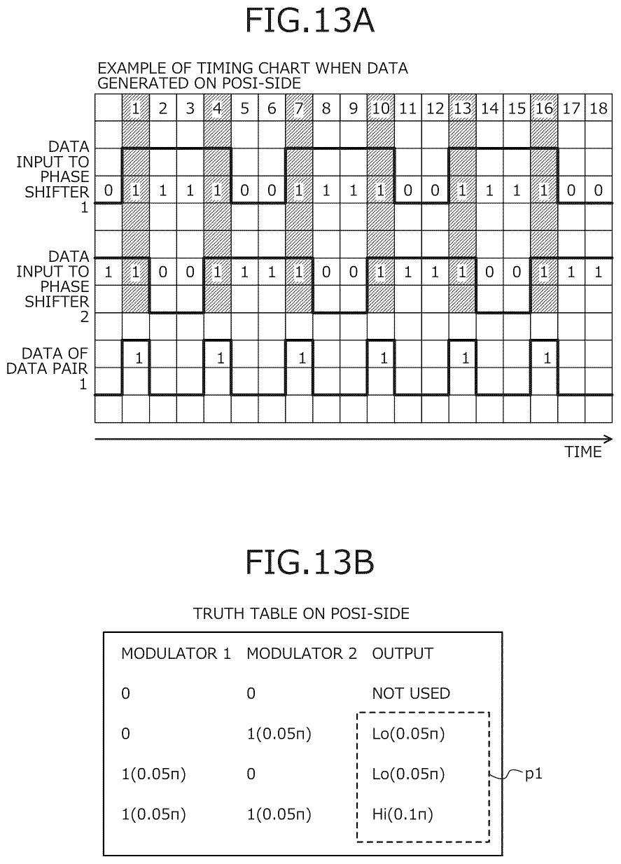

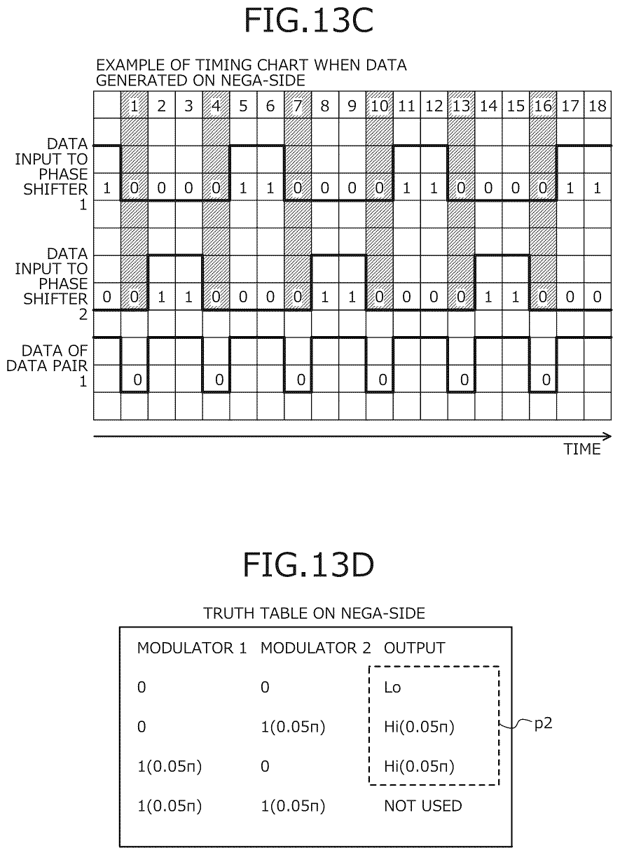

FIG. 13A is a timing chart depicting an example of signal generation on the positive-side when differential driving of the Mach-Zehnder optical modulator is assumed. FIG. 13A depicts an example of a timing chart in a case of generating data on the positive-side (a timing chart similar to FIG. 8A). In this case, similarly to the description above, the encoder 112 does not use the output of the value (0,0) of the data pairs 1 and 2 in the truth table depicted in FIG. 13B, and generates data using only a region p1 portion. The data signal indicating the positive-side corresponds to the data signal c(i).

FIG. 13C is a timing chart depicting a signal generation example on the negative-side in a case where differential driving of the Mach-Zehnder optical modulator is assumed. As depicted in FIG. 13C, the encoder 112 generates negative-side data by performing a logical operation or generating an inverted signal of the positive-side in addition to the output of the positive-side depicted in FIG. 13A. Here, the encoder 112 may generate data using a region p2 portion without using the output of the value (1,1) of the data pairs 1 and 2 in the truth table depicted in FIG. 13D. The data signal indicating the negative-side corresponds to the data signal d(i).

When a differential output of two arms of positive and negative is used as the optical modulator 103, the encoder 112 sets a state in which the optical modulator 103 is 0 so that a phase difference between the two arms becomes 0. In addition, the state in which the modulator 103 is 1 is set to a value in which the phase difference between the two arms is not 0.

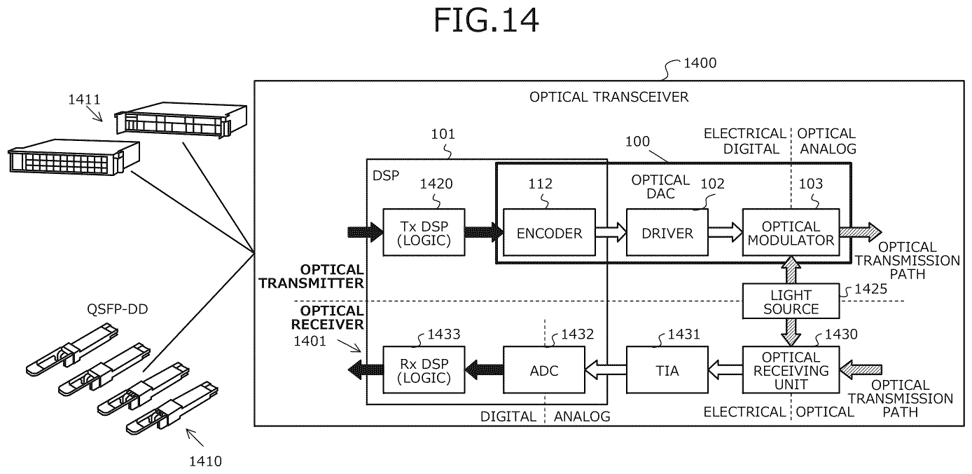

FIG. 14 is a block diagram depicting an example of an overall configuration of an optical transmitter. The optical transmitter (corresponding to the optical DAC) 100 of the above-described embodiment is applied to, for example, an optical transceiver 1400 integrated with an optical receiver 1401. The optical transceiver 1400 is provided as, for example, a Quad Small Form-factor Pluggable (QSFP) module 1410, and is accommodated in a rack housing 1411.

The optical transmitter (optical DAC) 100 constituting the optical transmission side according to the embodiment does not include an electric DAC, and includes the above-described units (including the bit mapping unit 111 (not depicted) and the encoder 112) in the DSP 101. The DSP 101 includes a transmission data processing unit (Tx) 1420 that performs transmission processing on input data. The DSP 101 drives the optical modulator 103 via the driver (CMOS inverter driver) 102. The optical transmitter (optical DAC) 100 converts an input digital electric signal into an analog optical signal and outputs the analog optical signal to an optical transmission path. A light source 1425 outputs local light to the optical modulator 103 and an optical receiving unit 1430. Note that both the DSP and the driver may be configured by CMOS circuits, and the electronic circuit may be formed into one chip by using the same technology.

The optical receiver 1401 includes the optical receiving unit 1430, a transimpedance amplifier (TIA) 1431, an ADC 1432, and a reception data processing unit (Rx) 1433. The optical receiving unit 1430 converts an analog optical signal received via the optical transmission path into an electrical signal. The TIA 1431 amplifies the received signal. The ADC 1432 converts the analog signal into a digital signal. The reception data processing unit 1433 performs reception data processing on the received signal.

The DSP 101 includes functions of a transmission data processing unit 1420 provided on the optical transmitter (optical DAC) 100 side, a bit mapping unit 111 (not depicted) constituting a part of the optical DAC 100, and the encoder 112. Further, as depicted in FIG. 14, the DSP 101 may include functions of the ADC 1432 and the reception data processing unit 1433 provided on the optical receiver 1401 side.

Since the optical transmitter has to process a signal at high speed, a dedicated DSP is currently used. The present disclosure is not limited hereto, and an ASIC or an FPGA corresponding to high-speed processing may also be used. Further, it is also possible to use a CPU whose speed is increased in the future. ASIC is an abbreviation for application specific integrated circuit, and FPGA is an abbreviation for field programmable gate array.

The optical transmitter according to the embodiment described above is an optical transmitter that includes an optical DAC that drives each of multiple modulation units using a binary driver and outputs an optical signal. The optical DAC generates a pair of data signals at different temporal timings for each gradation, outputs the pair of data signals of each gradation to a pair of modulation units provided for each of the multiple modulation units, performs optical modulation for each pair, and outputs an optical signal. As described, by modulating the pair of data signals generated by the time interleaving by the pair of modulation units, the baud rate of the data signal output to the modulation unit may be suppressed to half of the input signal, and the baud rate of the optical transmitter having the optical DAC may be increased.

The optical DAC includes: an encoder that divides a binary input signal into multiple data signals sampled at different temporal timings, and generates a pair of data signals at different timings from each of the divided data signals; a driver that amplifies the pair of data signals output by the encoder; and an optical modulator in which pairs of modulation units are arranged corresponding in number to the number of data signals, the optical modulator performs optical modulation by the pairs of modulation units along an optical waveguide based on the pair of data signals output by the driver, performs optical modulation for each pair, and outputs an optical signal. As described, the pair of modulation units, via the driver, modulates the pair of data signals generated by the time interleaving, whereby the baud rate of the data signal output to the modulation unit via the driver may be suppressed to half of the input signal. Therefore, even when the baud rate of the input signal is increased, it is possible to prevent signal loss in the driver portion and to increase the baud rate of the optical transmitter having the optical DAC.

In the optical transmitter according to the embodiment, the optical DAC generates, at the timing thereof, 1 or 0 for a pair of data signals and generates 0 at a timing other than the timing thereof. By adjusting the timing of the pair of data signals generated by time interleaving in this way, the amount of phase rotation of the pair of data signals in the modulation units may be made appropriate, and stable operation may be performed even at a high rate.

In addition, in the optical transmitter according to the embodiment, when the value has changed, the pair of modulation units does not change the value at the next timing, and at the timing assigned to the pair of modulation units, when the input signal is 1, the pair of modulation units generates a data signal in which both data signals of the two modulation units constituting the pair are set to a state of 1, when the input signal is 0, one data signal of the two modulation units is set to 1 and the other data signal is set to 0, and at the timing other than the timing assigned to the pair of modulation units, one data signal of the two modulation units is set to 1 and the other data signal is set to 0. As a result, for a pair of data signals generated by time interleaving, (N−1) UI of timing slots in which the value of the pair of data signals is 0 after change may be ensured (N is the number of interleaves), the phase rotation amount in the modulation unit may be appropriately set, and stable operation may be performed even at a high rate.

In the optical transmitter according to the embodiment, the sum of the phase differences of the pair of modulation units when the pair of modulation units generate 0 is half the sum of the phase differences of the pair of modulation units when the pair of modulation units generate 1. As a result, the amount of phase rotation in the modulation units may be made appropriate, and stable operation may be performed even at a high rate.

In the optical transmitter according to the embodiment, when the modulation units are used in differential driving, the phase difference between the two arms is set to 0 when the pair of modulation units is 0, and the phase difference between the two arms is set to a value other than 0 when the pair of modulation units is 1. This makes it possible to appropriately control the positive side and the negative side during differential driving.

In the optical transmitter according to the embodiment, the number of interleaves at different temporal timings is three or more, and the number of pairs of modulation units is a multiple of the number of interleaves. For example, in a case of three interleaves, a pair of data signals divided into three is output to each of three pairs of modulation units. In the embodiment, it is possible to obtain an effect of suppressing the rate output to the modulation units by three or more interleaves.

According to the optical transmitter of the embodiment, it is possible to provide an optical transmitter that includes an optical DAC capable of achieving a high baud rate.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmitter comprising an optical DAC that drives each of a plurality of modulation units using a binary driver and outputs an optical signal, wherein
the optical DAC is configured to generate a pair of data signals with different temporal timings for each gradation, output the pair of data signals of each gradation to a pair of modulation units of the plurality of pairs of modulation units provided for each of the plurality of modulation units, perform optical modulation on the pair of data signals of each gradation, and output the optical signal.

2. The optical transmitter according to claim 1, wherein the optical DAC generates for the pair of data signals, 1 or 0 at a timing of the optical DAC and 0 at a timing other than the timing thereof.

3. The optical transmitter according to claim 2, wherein
the pair of modulation units, after a value changes, does not change the value at a next timing,
the pair of modulation units, when an input signal is 1, sets both data signals of two modulation units constituting the pair of modulation units are set to a state of 1, and when the input signal is 0, one data signal of the two modulation units is set to 1 and the other data signal is set to 0, and
the pair of modulation units generates a data signal in which the data signal of one of the two modulation units is set to 1 at a timing other than the timing assigned thereto and the data signal of the other of the two modulation units is set to 0 at a timing other than the timing assigned thereto.

4. The optical transmitter according to claim 2, wherein a sum of phase differences of the pair of modulation units when the pair of modulation units generate 0 is half a phase difference of a sum of the phase differences of the pair of modulation units when the pair of modulation units generate 1.

5. The optical transmitter according to claim 2, wherein when the pair of modulation units is used in differential driving:
a phase difference between two arms is set to be zero when the pair of modulation units is zero, and
the phase difference between the two arms is set to a value other than 0 when the pair of modulation units is 1.

6. The optical transmitter according to claim 1, wherein
a number of interleaves at the different temporal timings is three or more, and
a number of pairs of modulation units is a multiple of the number of interleaves.

7. An optical transmitter comprising an optical DAC, the optical DAC having:
an encoder configured to divide a binary input signal into a plurality of data signals sampled at different temporal timings and generating a pair of data signals at timings respectively different from the divided plurality of data signals;
a driver configured to amplify the pair of data signals output from the encoder; and
an optical modulator in which a plurality of pairs of modulation units is arranged in a number corresponding to a number of the plurality of data signals, the optical modulator by a pair of modulation units of the plurality of pairs of modulation units along an optical waveguide, performing optical modulation based on the pair of data signals output from the driver and outputting an optical signal.

8. The optical transmitter according to claim 7, wherein the optical DAC generates for the pair of data signals, 1 or 0 at a timing of the optical DAC and 0 at a timing other than the timing thereof.

9. The optical transmitter according to claim 8, wherein
the pair of modulation units, after a value changes, does not change the value at a next timing,
the pair of modulation units, when an input signal is 1, sets both data signals of two modulation units constituting the pair of modulation units are set to a state of 1, and when the input signal is 0, one data signal of the two modulation units is set to 1 and the other data signal is set to 0, and
the pair of modulation units generates a data signal in which the data signal of one of the two modulation units is set to 1 at a timing other than the timing assigned thereto and the data signal of the other of the two modulation units is set to 0 at a timing other than the timing assigned thereto.

10. The optical transmitter according to claim 8, wherein a sum of phase differences of the pair of modulation units when the pair of modulation units generate 0 is half a phase difference of a sum of the phase differences of the pair of modulation units when the pair of modulation units generate 1.

11. The optical transmitter according to claim 8, wherein when the pair of modulation units is used in differential driving:
a phase difference between two arms is set to be zero when the pair of modulation units is zero, and
the phase difference between the two arms is set to a value other than 0 when the pair of modulation units is 1.

12. The optical transmitter according to claim 7, wherein the encoder includes:
a sampling processing unit configured to sample the binary input signal at the different temporal timings to divide the binary input signal into the plurality of data signals;
a 1UI shift configured to shift by one timing slot, the divided plurality of data signals of the different temporal timings output from the sampling processing unit; and
a logical operation unit configured to output to the pair of modulation units, a logical operation output of the divided plurality of data signals of the different temporal timings output by the sampling processing unit and a data signal output by the 1UI shift.

13. An encoding method of an optical transmitter including an optical DAC that drives each of a plurality of modulation units using a binary driver and outputs an optical signal, the encoding method comprising:
generating, by the optical DAC, a pair of data signals with different temporal timings for each gradation, outputting the pair of data signals of each gradation to a pair of modulation units of the plurality of pairs of modulation units provided for each of the plurality of modulation units, perform optical modulation on the pair of data signals of each gradation, and output the optical signal.
